(19) United States
(12) Patent Application Publication
(10) Pub. No.: US 2008/0137982 A1
(43) Pub. Date: Jun. 12, 2008

(54) Blurring determination device, blurring determination method and printing apparatus

(76) Inventor: Ayahiro Nakajima, Matsumoto-shi (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/999,425

(22) Filed: Dec. 4, 2007

(30) Foreign Application Priority Data
Dec. 6, 2006 (JP) 2006-329112
Oct. 10, 2007 (JP) 2007-264691

(51) Int. Cl. G06K 9/40

(52) U.S. Cl. 382/264

(57) ABSTRACT

The blurring determination device references image data in which are recorded coefficients that are obtained when pixel values forming the image in the spatial domain are converted to the frequency domain, and detects edges oriented in two or more directions, from among the image data, by comparing a series of the coefficients in each of the directions with various types of basic edge patterns whereby typical gradient patterns of the changes in pixel values are represented by values corresponding the coefficients. The representative values of the width of the detected edges is determined in each of the directions, and the image data is determined to not be blurred when the representative values meet the condition of being at or below a certain threshold.

### CLAIM OF PRIORITY

The present application claims the priority based on Japanese Patent Applications No. 2006-329112 filed on Dec. 6, 2006 and No. 2007-264691 filed on Oct. 10, 2007, the disclosures of which are hereby incorporated by reference in their entirety.

### BACKGROUND

1. Technical Field

The invention relates to a technique for detecting blurring in images.

2. Related Art

Digital still cameras have recently become popular, and the capacity of the memory cards used therein have been expanded. As a result, more and more general users are storing greater amounts of images. Digital still cameras require no film and allow photographs to be taken more casually, often resulting in photographing with unintentional blurring or object motion. As such, images are relatively often blurred due to blurring or object motion, and attempts to print such images on a printing apparatus require normal images to be selected beforehand.

It is extremely cumbersome to have to select normal images from out of an abundance of images. A desirable technique would therefore automatically exclude blurred images from the images to be printed before the user prints the images. In relation to such a technique for detecting blurring, JP-A-2006-19874 discloses a technique for detecting whether or not there is any blurring in images based on bit map data in the digital still camera used to photograph the images.

However, since recent digital still cameras can photograph images with a high resolution of several millions to ten millions of pixels, the bit map data volume can be quite extensive. As a result, CPUs with a high processing capacity and greater memory volume are needed, resulting in greater manufacturing costs, in order to detect blurring based on bit map data in compact devices such as digital still cameras and printers.

### SUMMARY

In view of the various problems noted above, an object which the present invention is intended to address is to detect blurring in images while minimizing the processing burden or the memory volume that is used.

In view of the foregoing object, the blurring determination device in an aspect of the invention comprises: an image data reference module configured to reference image data in which has been recorded coefficients that are obtained when pixel values forming the image in the spatial domain are converted to the frequency domain; an edge detection module configured to detect edges oriented in two or more directions, from among the image data, by comparing a series of the coefficients in each of the directions with various types of basic edge patterns whereby typical gradient patterns of the changes in pixel values are represented by values corresponding to the coefficients; and a blurring determination module configured to determine the representative values of the width of the detected edges in each of the directions and determine that the image data is not blurred when the representative values meet the condition of being at or below a certain threshold.

According to the blurring determination device in the above aspect, the coefficients recorded in the image data are used as such, without being converted to pixel values, to determine whether images are blurred. Blurring can thus be rapidly determined, with less of a process load for determining blurring. In addition, according to the blurring determination device in the above aspect, there is no need to ensure memory area for the conversion of the coefficients to pixel values during the blurring determination process. The memory volume that is used can therefore be decreased. Furthermore, according to the blurring determination device in the above aspect, edges are detected in two or more directions among the image data, and images are determined not to be blurred when the representative values of the width of the edges in each direction are at or below a certain threshold. Blurring can thus be accurately determined without depending on the direction of blurring. “Edge” refers to a border where there is a precipitous change in pixel values (such as luminance, hue, RBG values) in an image. “Edge width” refers to the width of the border. When the “edge width” expands, the border component becomes blurred. The “edge direction” refers to the normal directions of the border noted above.

Aspects of the invention other than the above blurring determination device can also comprise a printing apparatus, blurring determination method, and computer program. The computer program may be recorded on computer-readable recording media. Examples of recording media include a variety of media such as floppy disks, CD-ROM, DVD-ROM, opticomagnetic disks, memory cards, and hard disks.

These and other objects, features, aspects, and advantages of the present invention will become more apparent from the following detailed description of the preferred embodiments with the accompanying drawings.

### BRIEF DESCRIPTION OF THE DRAWINGS

FIG. 1 shows an appearance of printer in an embodiment of the invention;

FIG. 2 shows an internal structure of printer;

FIG. 3 is an illustration of data recorded per block in JPEG data;

FIG. 4 shows a detailed structure of JPEG decoder;

FIG. 5 shows series of DCT;

FIG. 6 is a flow chart of printing process;

FIG. 7 is a flow chart of blurring determination process;

FIG. 8 shows an outline of band region;

FIG. 9 is a flow chart of process for determining blurring in blocks;

FIG. 10 is a flow chart of process for determining blurring in blocks;

FIG. 11 shows a specific example of an edge pattern table;

FIG. 12 shows variations of edge pattern tables;

FIG. 13 shows a correspondence of coefficient codes to referenced table;

FIG. 14 shows an outline of process for joining edge patterns;

FIG. 15 shows an outline of process for joining edge patterns;

FIG. 16 shows an outline of process for joining edge patterns;

FIG. 17 is a detailed flow chart of process for matching edge patterns by direction;

FIG. 18 is a flow chart of process for selecting table that will be used;

FIG. 19 shows a correspondence of coefficient signs to referenced table;

FIG. 20 shows an appearance of photo viewer in second embodiment;

FIG. 21 shows an appearance of kiosk terminal in third embodiment; and

FIG. 22 shows an example of edge pattern table for block size of 4×4.

### DESCRIPTION OF THE PREFERRED EMBODIMENT

Modes for implementing the invention will be elaborated in the following order based on the embodiments below.

1st Embodiment

A. Printer Structure

B. Printing Process

C. Blurring Determination Process

D. Effects

2nd Embodiment

3rd Embodiment

4. Modifications

5. Other Aspects

### 1. 1st Embodiment

A. Printer Structure

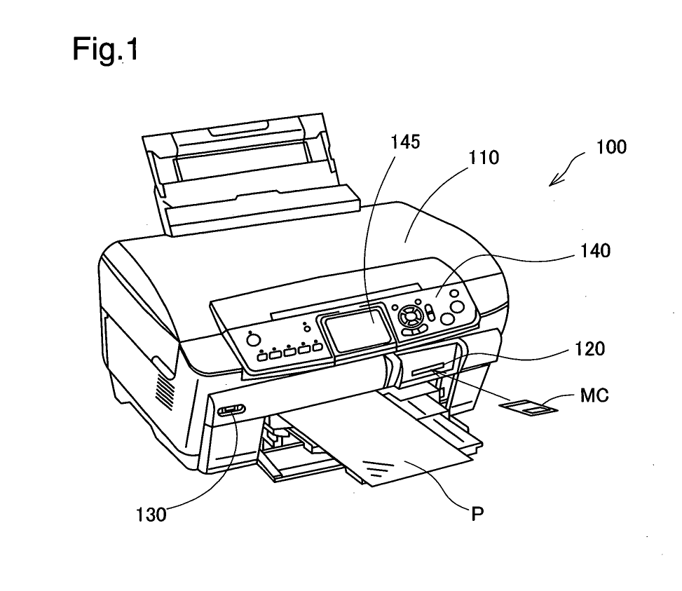

FIG. 1 illustrates the appearance of a printer 100 as an embodiment of the invention. The printer 100 is a multifunction printer. The printer 100 is equipped with a scanner 110 that optically scans images, a memory card slot 120 for inserting a memory card MC on which image data has been recorded, and a USB interface 130 for connecting devices such as digital cameras. The printer 100 is able to print images scanned by the scanner 110, images read from the memory card MC, and images read from a digital camera via the USB interface 130 on printing paper P. The printer 100 can also print images input from a personal computer (not shown) connected by a printer cable or USB cable.

The printer 100 is equipped with an operating panel 140 for a variety of printing-related operations. A liquid crystal display 145 is provided in the center of the operating panel 140. Displayed on the liquid crystal display 145 are images read from the memory card MC, digital camera, or a GUI (graphical user interface) when the various functions of the printer 100 are employed.

The printer 100 has the function of eliminating blurred images (“blurred images”) from among the plurality of image data input from the memory card MC, digital camera, and extracting images that are focused in even one location (“focused images”) for display on the liquid crystal display 145. The user can select desired images from among the images displayed on the liquid crystal display 145 to print images that are suitable for printing. The printer 100 structure and process for executing the function of eliminating blurred images are described in detail below.

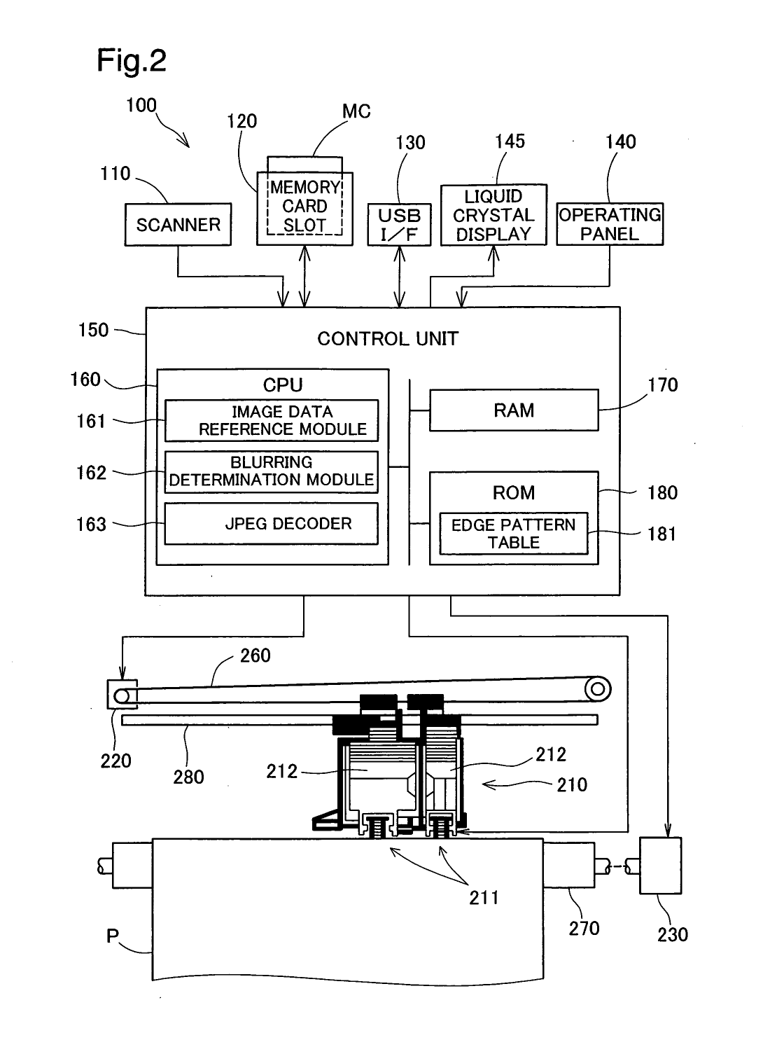

FIG. 2 illustrates the internal structure of the printer 100. As illustrated, As a mechanism for printing on the printing paper, the printer 100 is equipped with a carriage 210 on which ink cartridges 212 are mounted, a carriage motor 220 for driving the carriage 210 in the main scanning direction, a paper feed motor 230 for feeding the printing paper P in the sub-scanning direction.

The carriage 210 is equipped with a total of 6 ink heads 211 corresponding to the inks representing the colors of cyan, magenta, yellow, black, light cyan, and light magenta. The ink cartridges 212 housing these inks are mounted on the carriage 210. The inks supplied from the ink cartridges 212 to the ink heads 211 are ejected onto the printing paper P when piezo elements (not shown) are actuated.

The carriage 210 is movably supported by a sliding shaft 280 located parallel to the axial direction of the platen 270. The carriage motor 220 rotates a drive belt 260 according to commands from a control unit 150, so that the carriage 210 travels reciprocally parallel to the axial direction of the platen 270, that is, in the main scanning direction. The paper feed motor 230 rotates the platen 270 to feed printing paper P perpendicular to the axial direction of the platen 270. That is, the paper feed motor 230 can relatively move the carriage 210 in the sub-scanning direction.

The printer 100 is equipped with the control unit 150 to control the operation of the above ink heads 211, carriage motor 220, and paper feed motor 230. Connected to the control unit 150 are the scanner 110, the memory card slot 120, the USB interface 130, the operating panel 140, and the liquid crystal display 145 which are illustrated in FIG. 1.

The control unit 150 comprises a CPU 160, a RAM 170, and a ROM 180. Stored in the ROM 180 are a control program for controlling the operation of the printer 100 and an edge pattern table 181 used in the blurring determination process described below. The CPU 160 runs the control program stored in the ROM 180 by loading it to the RAM 170 to execute the illustrated functional modules (161 to 163).

The control unit 150 is equipped with an image data reference module 161, blurring determination module 162, and JPEG decoder 163 as the functional modules run by the CPU 160. The operations of these functional modules are briefly described below (see the contents of the various processes described below for more detailed operations).

The image data reference module 161 is a module by which the JPEG format image data (“JPEG data” below) recorded on the memory card MC or digital camera is referenced through the memory card slot 120 or USB interface 130. Images are recorded in 8 pixel×8 pixel block units in JPEG data. The image data in these blocks is compressed in the following order: 1) conversion of pixel values from RGB color space to YCbCr color space; 2) discrete cosine transform (DCT) from the spatial domain to the frequency domain; 3) quantization in which data volume is reduced; and 4) Huffman coding, which is a form of entropy encoding.

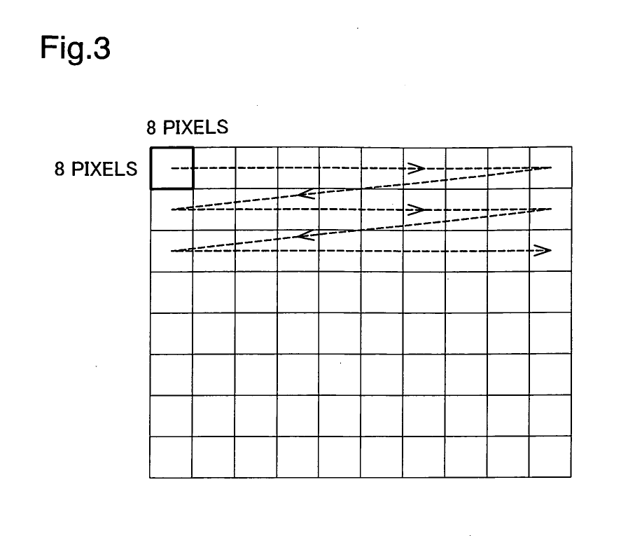

FIG. 3 illustrates data recorded per block in JPEG data. As illustrated, 8 pixel×8 pixel blocks are recorded row by row in the JPEG data. Although the data in each block may also be recorded in other sequences in JPEG data, in this embodiment, the blocks are recorded in the sequence given in FIG. 3.

The JPEG decoder 163 (see FIG. 2) is a functional module by which the JPEG data referenced by the image data reference module 161 is decoded into data in bit map format.

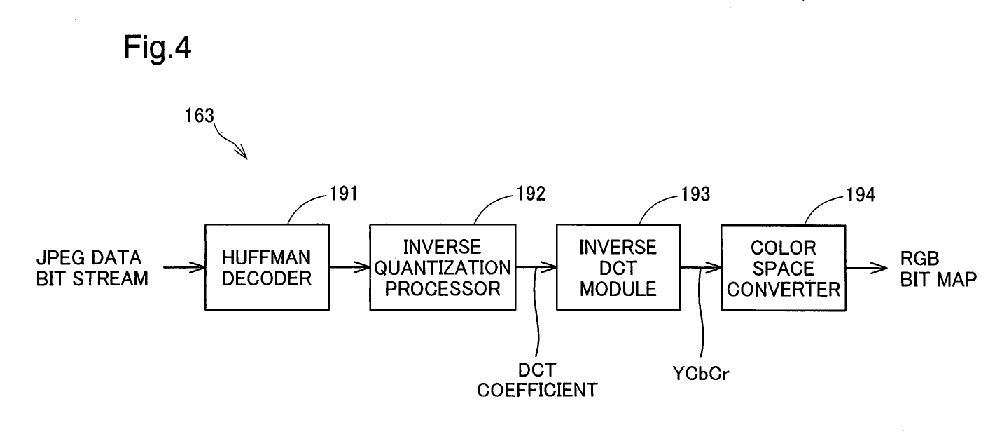

FIG. 4 is a detailed illustration of the structure of the JPEG decoder 163. As illustrated, the JPEG decoder 163 comprises a Huffman decoder 191, inverse quantization processor 192, inverse DCT module 193, and color space converter 194.

The Huffman decoder 191 has the function of decoding the JPEG data bit stream which has undergone lossless compression by means of Huffman coding.

The inverse quantization processor 192 is a functional module that uses a certain quantization table for inverse quantization of the data decoded by the Huffman decoder 191 to determine the 8×8 DCT coefficients per block.

The inverse DCT module 193 is a functional module for the inverse DCT of the DCT coefficients determined by the inverse quantization processor 192 to determine image data in the YCbCr format.

The color space converter 194 is a functional module by which the data in YCbCr format obtained by the inverse DCT module 193 is converted to bit map data in the RGB format.

Here, the description returns to FIG. 2. The blurring determination module 162 is a functional module wherein the Huffman decoder 191 and inverse quantization processor 192 with which the JPEG decoder 163 is equipped are used for the Huffman decoding and inverse quantization of the JPEG data to determine blurring based on the DCT coefficients that are thus obtained. The blurring determination module 162 of the embodiment corresponds to the “edge detection module” and “blurring determination module” of the invention.

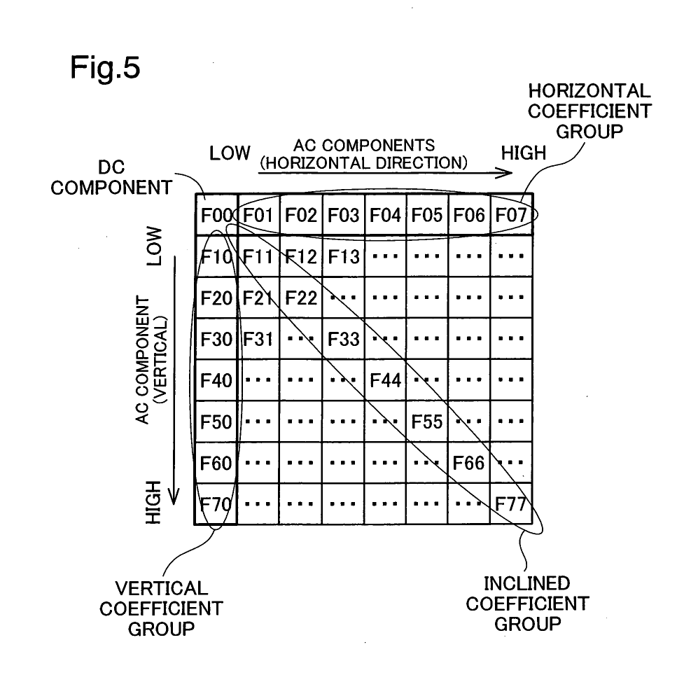

FIG. 5 illustrates a series of DCT coefficients that are obtained by the inverse quantization processor 192. As illustrated, from the blocks, a total of 64 DCT coefficients are obtained, from F00 to F77, at the stage where the inverse quantization has taken place. The coefficient F00 that is in the left uppermost position is referred to as the DC component, and the other coefficients are referred to as AC components. The closer the coefficients are to the right and bottom, the higher the frequency.

The blurring determination module 162 has the function of determining blurring by extracting coefficients F01, F02, F03, F04, F05, F06, and F07 that are AC components only in the horizontal direction described as “horizontal coefficient group” in the figure, coefficients F10, F20, F30, F40, F50, F60, and F70 that are AC components only in the vertical direction described as “vertical coefficient group,” and coefficients F11, F22, F33, F44, F55, F66, and F77 that are AC components in the inclined direction described as “inclined coefficient group.” Details on the blurring determination process using these coefficient groups are given below.

B. Printing Process

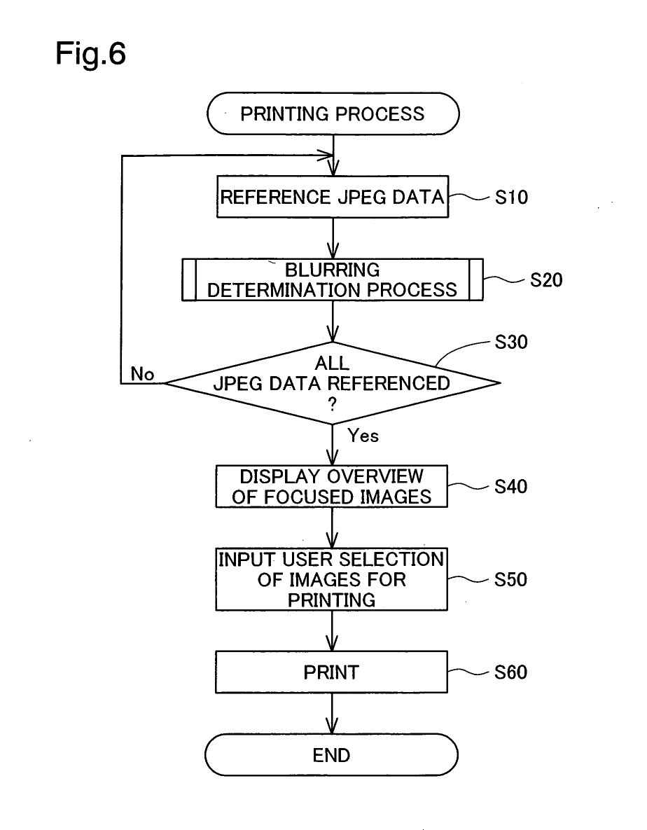

FIG. 6 is a flow chart of the printing process carried out by the CPU 160 of the printer 100. The printing-process is carried out to print image data recorded on the memory card.

When the printing process is started in response to certain operations by a user manipulating the operating panel 140, first the CPU 160 references a JPEG data set recorded on a memory card MC by means of the image data reference module 161 (Step S10). Here, the JPEG data on a memory card was referenced, but the JPEG data on a computer or digital camera connected by the USB interface 130 can also be referenced.

When JPEG data is referenced, the CPU 160 uses the blurring determination module 162 to carry out the blurring determination process on the referenced JPEG data (Step S20). Details on the blurring determination process are given below.

When the blurring determination process for one set of JPEG data is finished, the CPU 160 determines whether all the JPEG data on the memory card MC has been referenced (Step S30). When it is determined by this process that not all of the JPEG data has been referenced (Step S30: No), the process returns to Step S10, and the next JPEG data set is referenced to carry out the blurring determination process on that JPEG data.

When it is determined in Step S30 that all of the JPEG data has been referenced (Step S30: Yes), an overview of the JPEG data determined to be focused images by the blurring determination process in Step S20 is displayed by the CPU 160 on the liquid crystal display 145 (Step S40).

When the overview of the focused images is displayed on the liquid crystal display 145, the CPU 160 receives the user's selection of the images for printing via the operating panel 140 (Step S50). The selected image data format is converted with the use of the JPEG decoder 163 from JPEG format to bit map format, and is furthermore converted to data to control the amount of ink injection, and the ink heads 211, paper feed motor 230, and carriage motor 220 are controlled for printing (Step S60).

In the printing process noted above, all the JPEG data on the memory card MC was referenced, but when a plurality of folders have been created on a memory card, it is also possible to reference just the JPEG data included in folders indicated by the user. It is also possible to reference only JPEG data taken in a certain year or month or on a certain day.

C. Blurring Determination Process

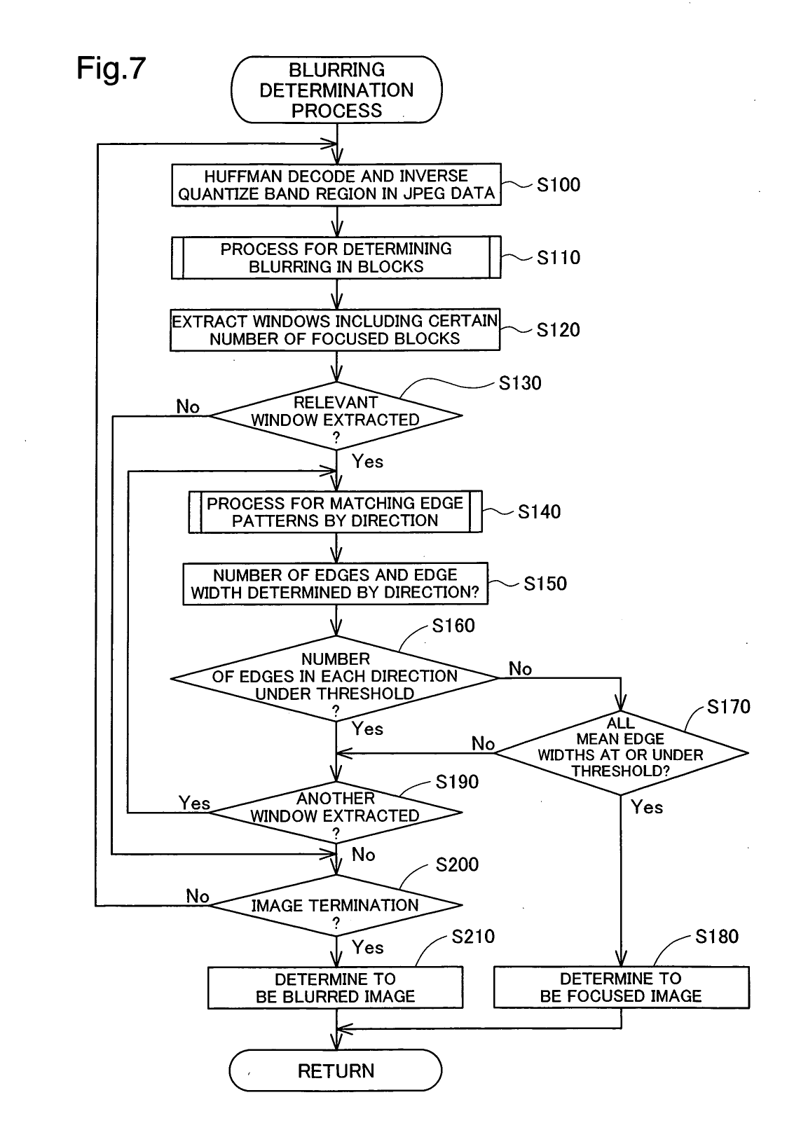

FIG. 7 is a flow chart of the blurring determination process run in Step S20 of the printing process illustrated in FIG. 6. This blurring determination process is carried out to determine whether the currently referenced JPEG data is focused images or blurring images.

When the blurring determination process is carried out, the CPU 160 first reads block data per certain band region from among the currently referenced JPEG data, and the data undergoes Huffman decoding and inverse quantization using the JPEG decoder 163 to obtain DCT coefficients (Step S100). The DCT coefficients that are obtained are temporarily stored in RAM 170.

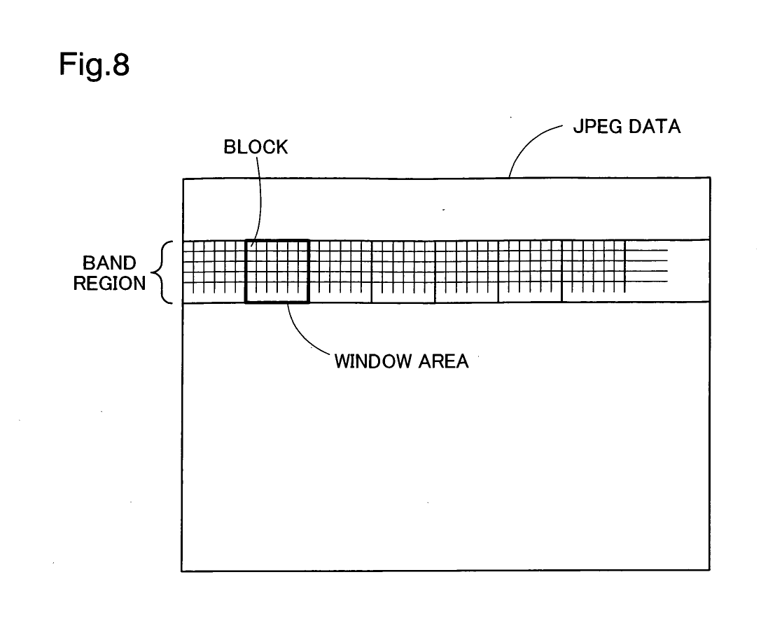

FIG. 8 outlines the “band region” noted above. As illustrated, in this embodiment, “band region” refers to a band-shaped region in which the number of blocks in the horizontal direction is the same as the number of blocks of JPEG data in the horizontal direction, and there is a certain number of blocks in the vertical direction (such as 30 blocks). In the above Step S100, DCT coefficients are obtained by Huffman decoding and inverse quantization of the block data in the band region as the data is read from the JPEG data. The storage volume of the RAM 170 can be reduced by reading data from the JPEG data per band-shaped region, not the entire image.

Returning to FIG. 7, when the DCT coefficients in the band region are stored in RAM 170 in Step S100 above, the CPU 160 then runs a block blur determination process based on the DCT coefficients stored in RAM 170 (Step S110).

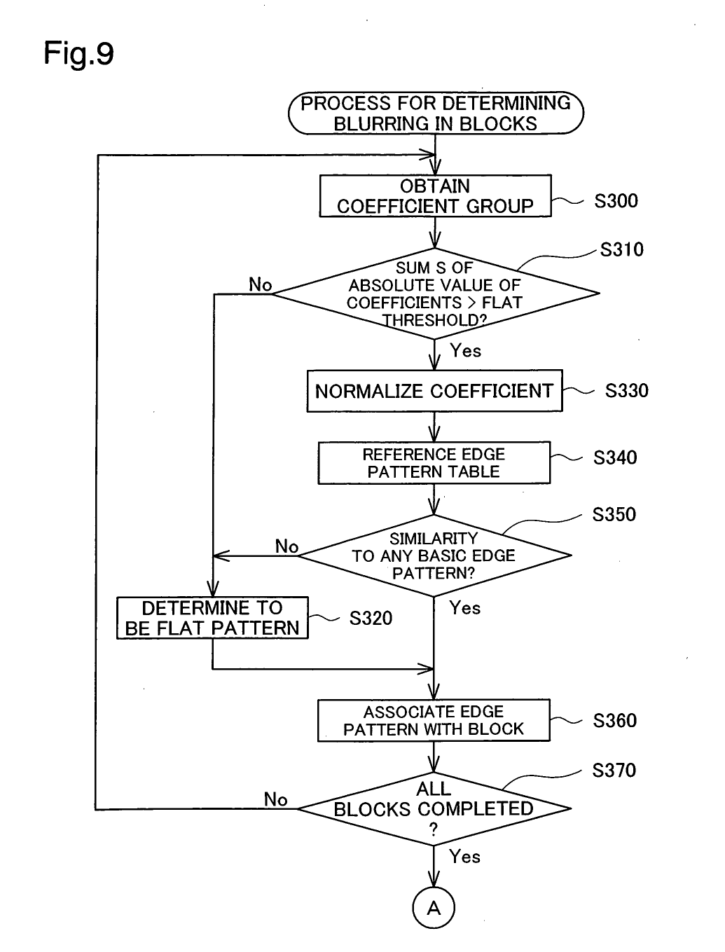

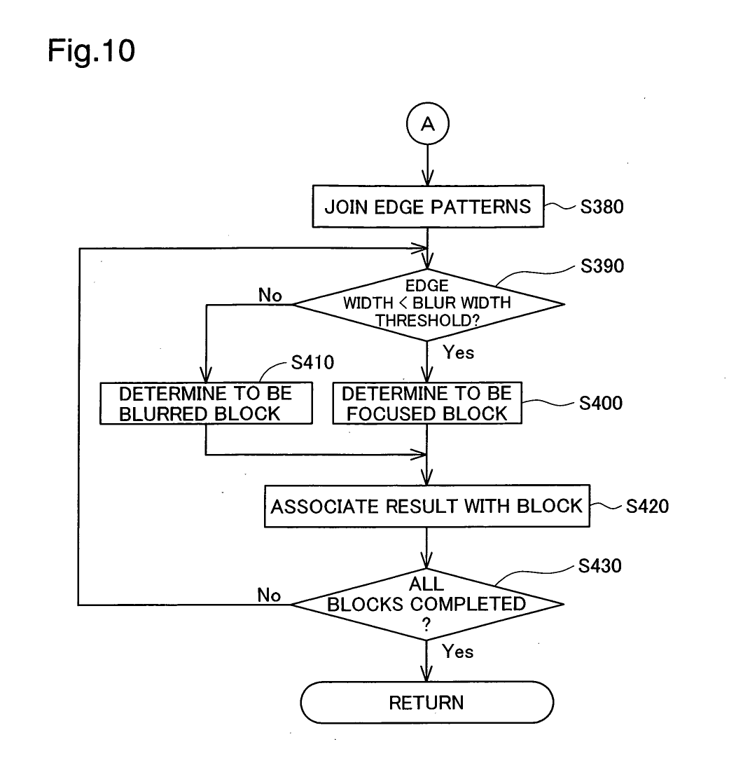

FIGS. 9 and 10 are flow charts of the block blur determination process. This is a process in which the horizontal coefficient group and vertical coefficient group in FIG. 5 are used to determine whether all the blocks in the band region stored in RAM 170 are “focused blocks” or “blurred blocks.” Unless otherwise noted, the process for determining blurring in blocks will be described below for cases in which blurring in the horizontal direction is analyzed, since the process is the same for blocks in both the horizontal and vertical directions.

When the block blur determination process is carried out, the CPU 160 first obtains a horizontal coefficient group F0i (i=1 to 7), which is an AC component in the horizontal direction illustrated in FIG. 5, from among the 8×8 DCT coefficients constituting the blocks (vertical coefficient group Fj0 (j=1 to 7) in the case of the vertical direction) (Step S300).

When the coefficient group is obtained, the CPU 160 determines the sum S of the absolute values of each coefficient that has been obtained based on the following Equation (1), and determines whether the value is over a certain flat threshold (Step S310).

S=Σ|F0i|(i=1 to 7) (1)

In Step S310 above, when the sum S is determined to be at or below the certain flat threshold (Step S310: No), the change in luminance represented by the coefficient of the block subject to analysis is regarded as being flat, and this block is determined to be a “flat pattern” (Step S320).

Meanwhile, when the sum S is determined to be over the certain flatness threshold in Step S310 (Step S310: Yes), it can be determined that there has been some change in luminance in the block subject to analysis. The CPU 160 then first normalizes the obtained coefficients by the following Equation (2) to permit easier comparison with the basic edge patterns described below (Step S330). The coefficient values Fr01 through Fr07 normalized by means of the normalization process are values obtained by dividing the coefficient values F01 through F07 by the sum S of the absolute values of the coefficient group.

Fr0i=F0i/S(i=1 to 7) (2)

The CPU 160 then references the edge pattern table 181 stored in ROM 180 (Step S340) to determine whether the gradient pattern represented by the normalized coefficient values Fr01 through Fr07 resemble any of the basic edge patterns (Step S350).

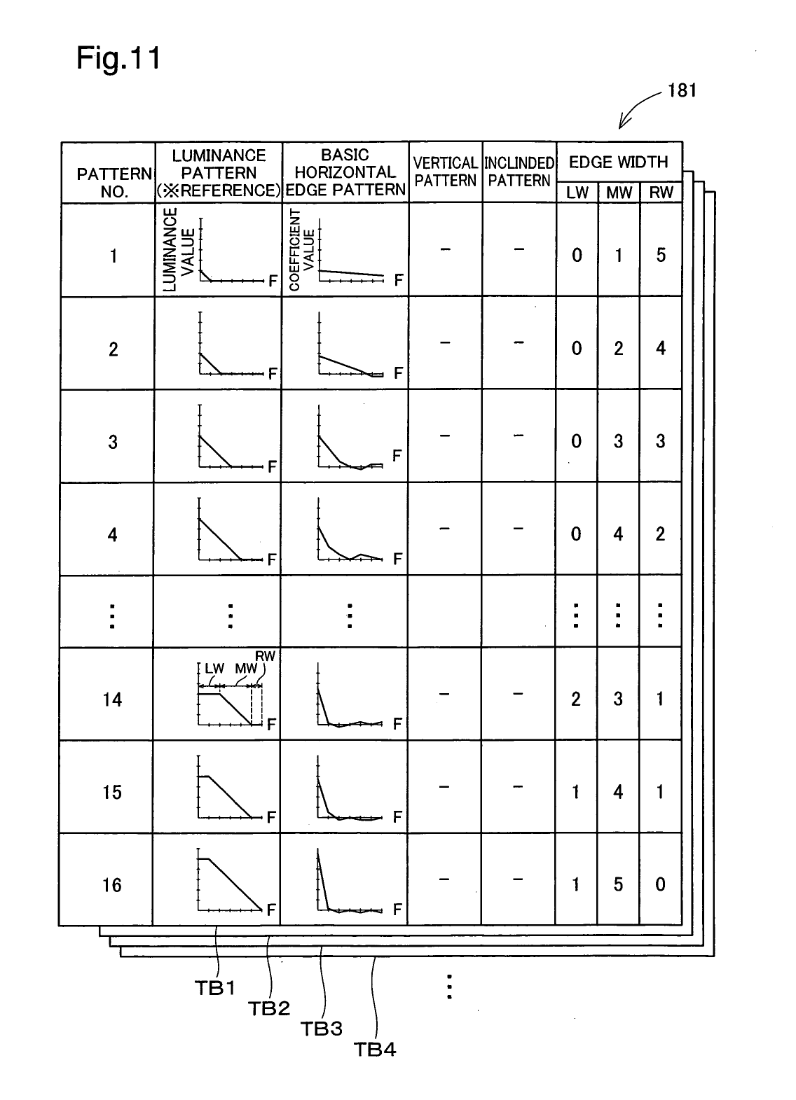

FIG. 11 illustrates an example of the edge pattern table 181. In the edge pattern table 181, 16 basic edge patterns (3rd column in figure) are aligned with the corresponding pattern numbers “1” through “16” (1st column in figure). The horizontal axis of the basic edge patterns represents the location of the coefficients in the block (F01 through F07), and the vertical axis represents the normalized coefficient values Fr. In other words, the basic edge pattern is composed in terms of data consisting of seven coefficient values.

Each basic edge pattern is produced based on the luminance pattern shown in the 2nd column of FIG. 11. That is, the basic edge patterns in the 3rd column of FIG. 11 are produced by doing DCT and nomalizing the luminance patterns shown in the 2nd column of the figure. The luminance patterns in the figure are not actually recorded in the edge pattern table but are shown here to facilitate an understanding of the process. The luminance patterns represent typical patterns of changes in luminance in a block pre-arranged into 16 types. In this embodiment, the basic edge patterns are divided into 16 types in this manner, but they may also be divided into more or fewer types.

Also aligned with the basic edge patterns in the edge pattern table 181 are the three parameters of left edge width LW, middle edge width MW, and right edge width RW. The left edge width LW represents the width of the flat portion on the left side of the luminance pattern, and the right edge width RW represents the width of the flat portion on the right side of the luminance pattern. The middle edge width MW represents the width of the gradient flanked by the left edge width LW and right edge width RW.

FIG. 11 illustrates a specific example of part of the edge pattern table 181. The entire edge pattern table 18 is, in fact, composed of a 16 types of tables TB1 through TB16.

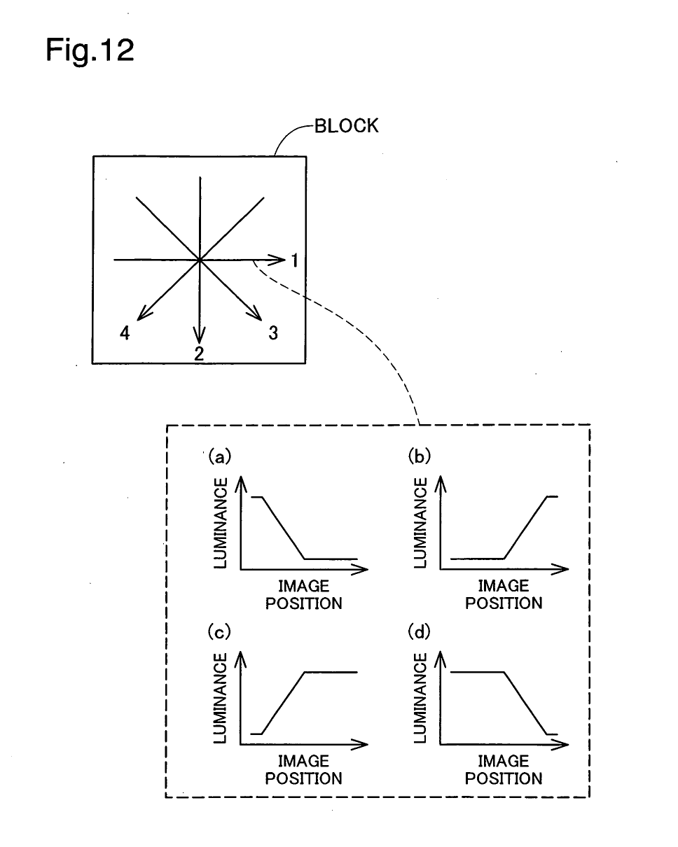

FIG. 12 illustrates variations in edge pattern tables. FIG. 12 illustrates a total of four directions, comprising the horizontal direction, vertical direction, inline from upper left to lower right, and incline from upper right to lower left, in the frame referred to as a “block.” FIG. 11 illustrates luminance patterns with a luminance gradient in the horizontal direction. However, the horizontal luminance patterns illustrated only in FIG. 11 are not the only ones. As illustrated in the bottom of FIG. 12, luminance patterns include (b) mirror images, (c) vertically inverted patterns, and (d) vertically inverted mirror images (these conditions of the luminance patterns are referred to below as “phases”). As four phase tables are thus prepared for each direction in the edge pattern table, 16 edge pattern tables TB1 through TB16 are prepared in all. In the edge pattern table for vertical luminance patterns, coefficients corresponding to changes in vertical luminance (F10, F20, F30, F40, F50, F60, and F70) are recorded as basic edge patterns. In the edge pattern table in which basic edge patterns in inclined directions are recorded, horizontal (F01, F02, F03, F04, F05, F06, F07), vertical (F10, F20, F30, F40, F50, F60, F70), and inclined (F11, F22, F33, F44, F55, F66, F77) are recorded as basic edge patterns. It is also possible to record only “F01” as the horizontal coefficient and only “F10” as the vertical coefficient in the inclined edge pattern table.

As noted above, there are 16 patterns in all in the edge pattern table 181, but the edge pattern table referenced in Step S340 above can be selected based on the signs of the two coefficient F01 and F02 (F10 an F20 when in the vertical direction) codes.

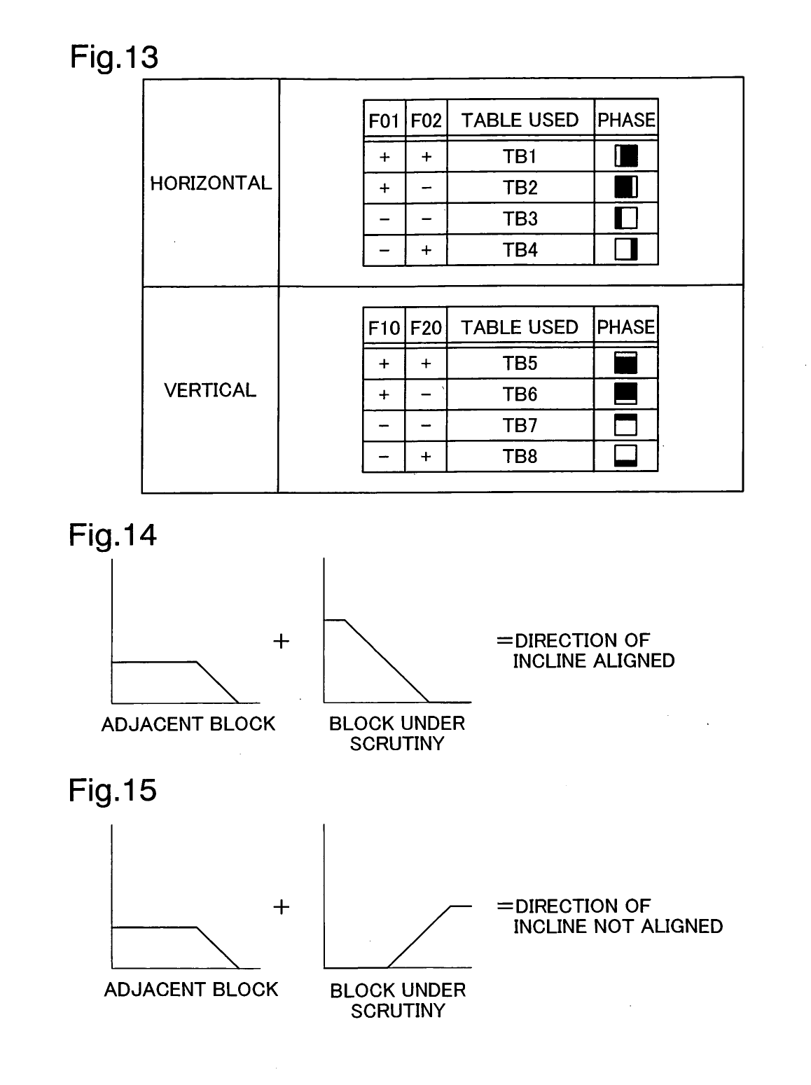

FIG. 13 illustrates the corresponding of the signs of the two coefficients to the reference table. When, as illustrated, blurring in the horizontal direction is analyzed, tables for referencing can be selected from edge pattern tables TB1 through TB4 according to the differences in the combinations of the signs of the coefficient F01 and F02. This is because the combinations of these signs are all different upon the calculation of the coefficients F01 and F02 for the four phases of the edge patterns illustrated at the bottom of FIG. 12. Similarly, when blurring in the vertical direction is analyzed, tables for referencing can be selected from edge pattern tables TB5 through TB8 according to the differences in the combinations of the signs of the coefficient F10 and F20. Narrowing down the options in advance for referencing edge pattern tables based on the two coefficients in this way can alleviate the processing load imposed on the CPU 160, without any need for searching the basic edge patterns described below in all 16 edge pattern tables. In the “Phase” column in FIG. 13, symbols indicating the phases by white and black regions are shown to facilitate an understanding. The symbols indicate that edge patterns with luminance values increasing from the black to white region in the blocks are recorded in the table.

Returning to the flow chart in FIG. 9, in Step S350 in FIG. 9, the total SD of the absolute value of the difference between the coefficient values Fr01 through Fr07 normalized in Step S330 and the coefficient values Fb01 through Fb07 constituting the basic edge pattern is calculated according to Formula (3) below. And the basic edge pattern with the lowest total SD is selected from among those in the edge pattern table 181. If the total SD of the selected basic edge pattern is lower than a certain threshold, it is determined that a basic edge pattern of similar shape has been retrieved (Step S350: Yes). On the other hand, if the SD obtained by the above calculations is greater than the certain threshold, it is determined that a similar basic edge pattern has not been retrieved (Step S350: No), and the block subject to analysis is determined to be a “flat pattern” (Step S320).

SD=Σ|Fr0i−Fb0i|(i=1 to 7) (3)

When a similar basic edge pattern has been retrieved in Step S350 above, or a flat pattern is determined in Step S320, the CPU 160 associates the edge pattern with the block (Step S360). It is determined whether edge patterns have been associated with all of the blocks in the band region (Step S370), and if not, the process returns to Step S300 to associate an edge pattern with the next block.

When it is determined in the above Step S370 that edge patterns have been associated with all blocks (Step S370: Yes), the CPU 160 runs a process for joining the horizontal and vertical edge patterns for the blocks in the band region (Step S380 in FIG. 10).

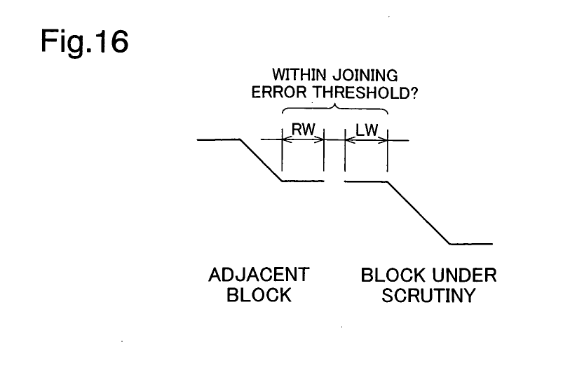

FIGS. 14 through 16 outline the process for joining the edge patterns. As shown in FIG. 14, for example, if the direction of the incline of the edge patterns in adjacent blocks is aligned, those edge patterns are considered to form the same blurred portion in the image. The CPU 160 thus determines whether the added values of the left edge width LW of the block under scrutiny and the right edge width RW of the adjacent block are within a certain joined error threshold, as shown in FIG. 16. If the values are within the joined error threshold, the edge patterns in these blocks can be concluded to form the same blurred portion. In such cases, the middle edge width MW of the two blocks are added to the right edge width RW and left edge width LW to calculate an edge pattern straddling the blocks. The edge width total is associated with the blocks currently subject to analysis, and the association of the edge width of other blocks in the blur is meanwhile “unknown.” Joining adjacent edge patterns in this manner will allow the width of the blur to be accurately determined even when the blurred portion in an image is greater than the size of 1 block. Meanwhile, when the direction of the incline of the edge pattern in the adjacent block is not aligned, as shown in FIG. 15, the edges are not joined, and the association of the edge width in the two blocks is “unknown.”

Returning to FIG. 10, when edge patterns have been associated with all the blocks in the band region through the above process, the CPU 160 determines whether the edge width associated with each block is under a certain blur width threshold (such as 12 pixels) (Step S390). If the result is that the edge width is less than the blur width threshold, the block is determined to be a “focused block” (Step S400). If the edge width in either the horizontal or vertical directions at that time meets the above conditions, a “focused image” is determined. If, on the other hand, the edge width is at or over the blur width threshold or the edge width is “unknown,” the block is determined to be a “blurred block” (Step S410).

When each of the blocks has thus been determined to be a “focused block” or “blurred block,” the CPU 160 associates the results with each block (Step S420). It is determined whether all of the blocks have been finished (Step S430), and if not, the process returns to Step S390 to determine whether the remaining blocks are focused. If, on the other hand, it is determined that all the blocks are finished, the CPU 160 finishes the process for determining blurring in blocks, and the process returns to the blurring determination process in FIG. 7.

Returning to FIG. 7, when it is determined by the above block blurring determination process (Step S110) whether each block in the band region is a “blurred block” or a “focused block,” the CPU 160 then divides the band region into a plurality of regions in the horizontal direction (these regions are referred to below as “window areas”) as illustrated in FIG. 8. The CPU 160 tallies the number of focused blocks in the window areas, and extracts the window areas with a total at or over a certain number (Step S120).

The size of the window areas, on L-ban size printing paper (8.9 cm×12.7 cm), for example, can be a size of 1 cm×1 cm, which will allow focusing to be determined for practical purposes (This size corresponds to a size of about 30×30 blocks, assuming an image of 6,000,000 pixels is printed on L-ban size printing paper).

When the window areas are extracted in Step S120 above (Step S130: Yes), the window areas can be assumed to be focused areas because of the abundance of focused blocks that are included. The CPU 160 then runs the process of Steps S140 through S170 below to strictly determine blurring in the window areas.

That is, the CPU 160 first references edge pattern tables by the four directions shown in FIG. 12 to carry out the pattern matching process (Step S140). The process is referred to below as the “process for matching edge patterns by direction.”

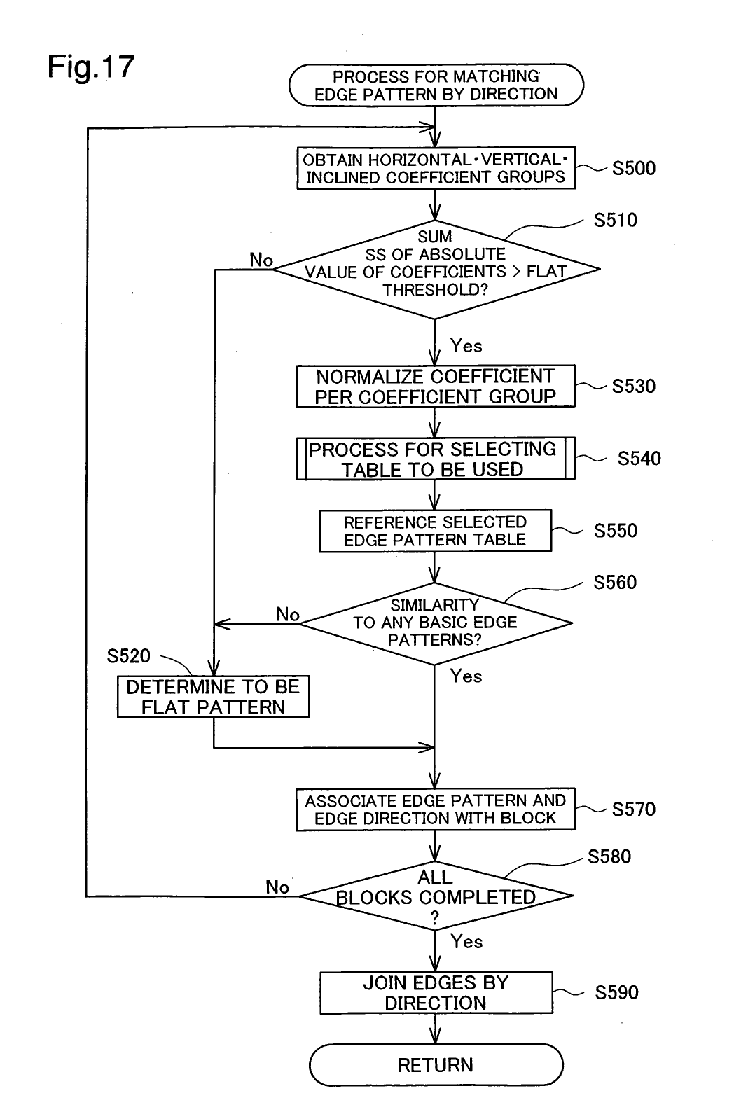

FIG. 17 is a detailed flow chart of the process for matching edge patterns by direction. The process for matching edge patterns by direction is carried out for all blocks belonging to the window areas extracted in Step S120 above.

When the process is started, the CPU 160 first obtains horizontal, vertical, and inclined coefficient groups for the current block (Step S500) (see FIG. 5). The sum SS of the absolute values of all coefficients constituting these coefficient groups is determined and compared to a certain threshold (Step S510). If comparison reveals the sum SS to be lower than the threshold (Step S510: No), the current block is determined to be a flat pattern (Step S520). By contrast, if the sum SS is at or over the threshold (Step S510: Yes), the coefficients are normalized in each direction (Step S530). The normalization approach is the same as the normalization in Step S330 of the above process for determining blurring in blocks.

When the coefficients are normalized per coefficient group, the CPU 160 carries out a process for selecting the table used in the following process from among the 16 edge pattern tables TB1 through TB16 (Step S540).

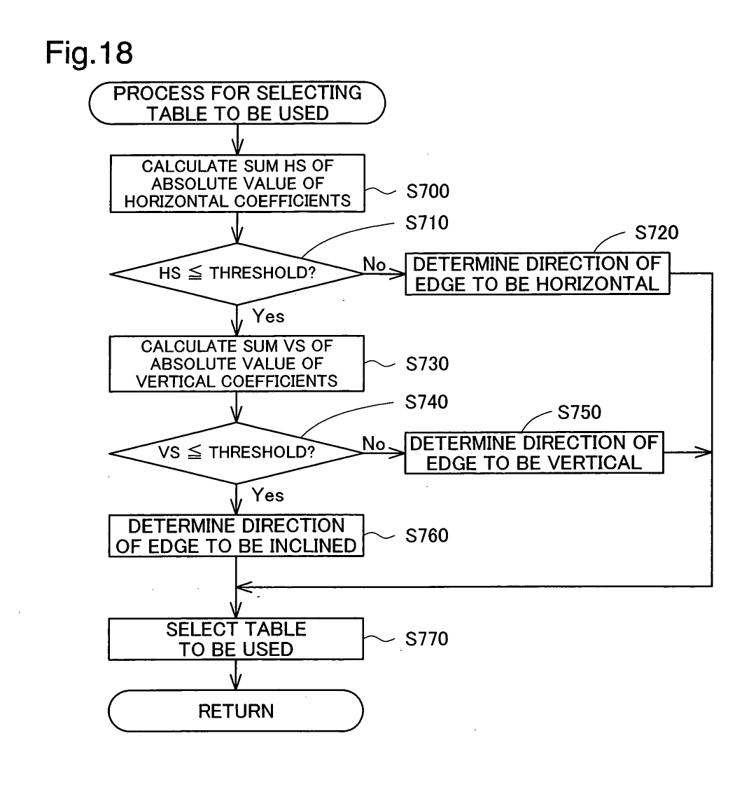

FIG. 18 is a flow chart of the process for selecting the table that is used. When the process is started, the CPU 160 first determines the sum HS of the absolute values of the coefficients constituting the horizontal coefficient group (Step S700), and compares the sum HS to a certain threshold (Step S710). If the results reveal the sum HS to be greater than the threshold (Step S710: No), the direction of the edge is determined to be in the horizontal direction because the change in luminance in the horizontal direction is considered substantial (Step S720).

If, on the other hand, the sum HS is at or below the threshold (Step S710: Yes), the sum VS of the absolute values of the coefficients constituting the vertical coefficient group is determined (Step S730), and the sum VS is compared to a certain threshold (Step S740). If the results reveal the sum VS to be greater than the threshold (Step S740: No), the direction of the edge is determined to be in the vertical direction because the change in luminance in the vertical direction is considered substantial (Step S750).

In the above Step S740, when the sum VS is determined to be at or below the threshold (Step S740: Yes), the change in luminance is not considered to be very substantial in either the horizontal or vertical directions, in which case the CPU 160 therefore determines the direction of the edge to be inclined (Step S760).

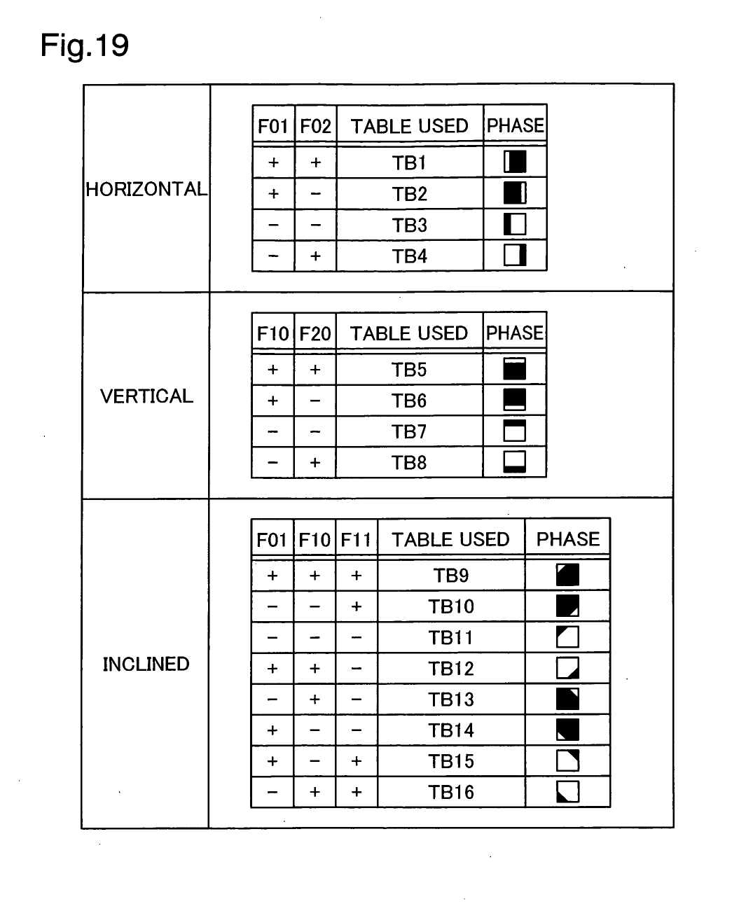

When the direction of the edge is determined by the above process, the CPU 160 carries out a process for selecting the edge pattern table that will be used (Step S770). Specifically, as illustrated in FIG. 19, when the direction of the edge is determined to be horizontal in Step S760 above, an edge pattern table is selected from tables TB1 through TB4 according to the combination of two signs of the coefficient F01 and F02, and in the case of the vertical direction, an edge pattern table is selected from edge pattern tables TB5 through TB8 according to the combination of two signs of the coefficient F10 and F20. In addition, when the direction of the edge is determined to be inclined, the edge pattern table that will be used is selected from tables TB9 through TB16 according to the combination of three signs of the coefficient F01, F10, and F11. In addition, when any of tables TB9 through TB12 is selected as the table that will be used, the CPU 160 determines the direction of the edge to be inclined from the upper left to the lower right. When any of tables TB13 through TB16 is selected, the direction of the edge is determined to be inclined from the upper right to the lower left. In the column showing the “Phases” in FIG. 19, symbols indicating the phases by white and black regions are shown in order to facilitate an understanding. The symbols indicate edge patterns with luminance values increasing from the black to white region in the blocks. The edge pattern table that will be used can be selected from tables TB9 through TB16 according to the combination of three signs of the coefficients F01, F10, and F11 when the direction of the edge is inclined because the combinations of signs for the coefficients F01, F10, and F11 are all different upon calculating the coefficients for the 4 phases in both inclined directions shown in FIG. 12 (direction from upper left to lower right and direction from upper right to lower left).

When an edge pattern table is selected by the above process, the CPU 160 returns the process to the process for matching edge patterns by direction in FIG. 17. The selected edge pattern table is then referenced (Step S550).

When the selected edge pattern table is referenced, the CPU 160 compares the coefficient groups of the basic edge pattern and the coefficient groups corresponding to the direction of the edge determined by the above process for selecting the table that is used in order to search for similar basic edge patterns (Step S560). This search process is the same as the process in Step S350 in FIG. 9. When no similar basic edge pattern is retrieved by such a process (Step S560: No), the current block is determined as being a flat pattern (Step S520).

When a similar basic edge pattern is retrieved in Step S560, or when the pattern is determined to be flat in Step S520, the CPU 160 associates the edge pattern and the direction of the edge with the block (Step S570). It is determined whether edge patterns have been associated with all of the blocks in the current window area (Step S580), and if not, the process returns to Step S500 to associate an edge pattern with the next block.

When it is determined by the above process that edge patterns have been associated with all blocks, the CPU 160 joins the edge patterns in the four directions shown in FIG. 12 (Step S590). The joining process can be carried out by the same process as the method described in Step S380 in FIG. 10. The width and direction of the joined edges are then associated with each block.

When the process for matching edge patterns by direction is completed in the above process, the CPU 160 returns the process to the blurring determination process in FIG. 7, and the number of edges and the width of the edges are collated by the directions shown in FIG. 12 for the current window area (Step S150). The number of edges is also the same value as the number of blocks associated with the width of the edges.

In Step S150 above, when the number of edges is collated in each direction, the CPU 160 determines whether the number of edges in all directions is less than a certain threshold (Step S160).

In Step S160 above, when it is determined that all directions include a number of edges at or over the certain threshold (Step S160: No), it may be concluded that a sufficient number of edges are in that window area. The CPU 160 therefore calculates the mean value as the representative width of the edges included per direction. It is then determined whether all the calculated mean edge width values per direction are at or under a certain threshold (Step S170). If, as a result, all the mean values in each direction are at or below the certain threshold, the image is determined to be a “focused image” (Step S180), and the blurring determination process is complete. In this case, that is because all four directions include a sufficient number of edges, the width of the edges is small enough, and the window area can be determined to be focused. If even one window area is focused in the entire image, the image can be determined to be a normal image that is focused at some point, resulting in the determination of a “focused image” in Step S180 without having to determine blurring in other window areas or band regions.

In Step S160 above, if the number of edges included in any direction is determined to be under the threshold (Step S160: No), that window area does not include a sufficient number of edges and is therefore determined to be blurred. The CPU 160 therefore finishes the blurring determination process for the current window area, and determines whether another window area has been extracted by the process in Step S120 above (Step S190). When another window area has been extracted (Step S190: Yes), the process returns to Step S140, and the above process (Steps S140 to S170) is repeated for that window area.

When the above process has been completed on all window areas extracted by the process in step S120 (Step S190: No), or when not even one window area including at leas the certain number of focused blocks has been extracted in Step S120 (Step S130: No), the CPU 160 determines whether the current band region is located at the end of the image (Step S200). If the current band region is the end of the image (Step S200: Yes), it will turn out that there are no focused window areas, and the current image is therefore determined to be a blurred image (Step S210). By contrast, if the current band area is not the end of the image (Step S200: No), the CPU 160 returns the process to Step S100, the next band region undergoes Huffman decoding and inverse quantization, and the above series of processes is repeated.

When the above blurring determination process is complete, the CPU 160 returns the process to the printing process shown in FIG. 6. When the blurring determination process described above is carried out on all the JPEG data recorded on a memory card, blurred images can be eliminated, allowing only focused JPEG data to be presented to the user.

D. Effects

According to the printer 100 in the embodiment described above, the storage volume in RAM 170 can be reduced because the JPEG data recorded on a memory card MC or the like can be divided into band regions and stored in RAM 170.

In the present embodiment, only window areas including an abundance of focused blocks are subject to detailed determination of blurring. This can thus alleviate the processing burden imposed on the CPU 160.

In the present embodiment, blurring can be rapidly determined because the entire image is determined to be focused when a window area is focused in any location.

In the present embodiment, blurring is determined based entirely on DCT coefficients, without converting the JPEG data to bit map format. The processing load imposed on the CPU 160 can therefore be alleviated, and blurring can be determined more rapidly.

In the present embodiment, edges are detected not only in the horizontal or vertical directions, but also in inclined directions, thus allowing it to be determined more accurately whether images are blurred, without being depending on the direction of camera.

### 2. 2nd Embodiment

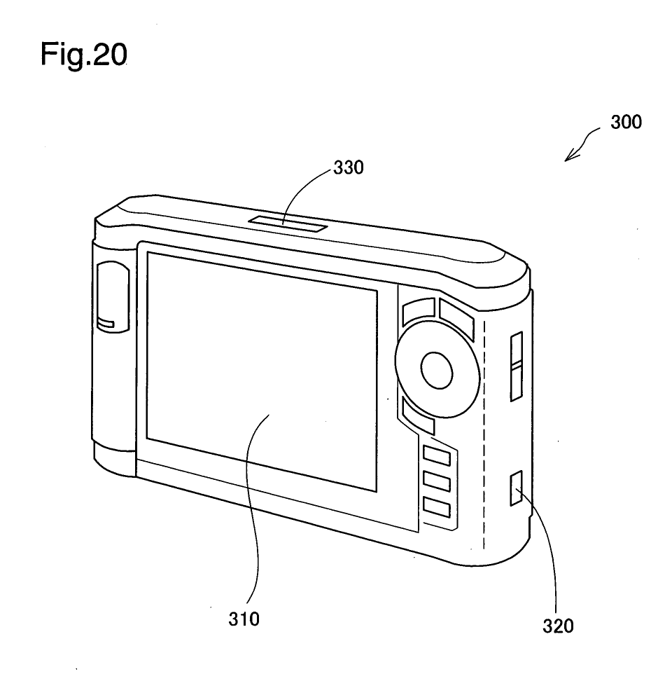

FIG. 20 illustrates the appearance of a photo viewer as a second embodiment of the invention. The photo viewer 300 of the present embodiment is equipped with a monitor 310, USB interface 320, and memory card slot 330. The interior is equipped with a CPU, RAM, and ROM, as well as a hard disk drive or flash memory storage device.

The photo viewer 300 has the function of allowing the image data recorded in a storage device to be displayed on the monitor 310. Images from a digital camera or personal computer are transferred via the USB interface 320 to the internal storage device. The photo viewer 300 reads images from memory cards that are inserted into the memory card slot 330 and transfers the images to the storage device. A printer can be connected to the USB interface 320. The photo viewer 300 controls the printer using an internally installed printer driver so as to print the image data stored in the storage device.

The CPU in the photo viewer 300 runs a control program stored in ROM by loading it in RAM so as to carry out the image transfer function or image display function described above. The CPU also runs the control program to carry out the same processes as the various processes described in the first embodiment (printing process and blurring determination process). The photo viewer 300 can thus automatically extract focused images from out of the image data stored in the storage device and display the images on the monitor 310. The photo viewer 300 can also control the printer connected to the USB interface 320 to print the focused images that have been extracted.

### 3. 3rd Embodiment

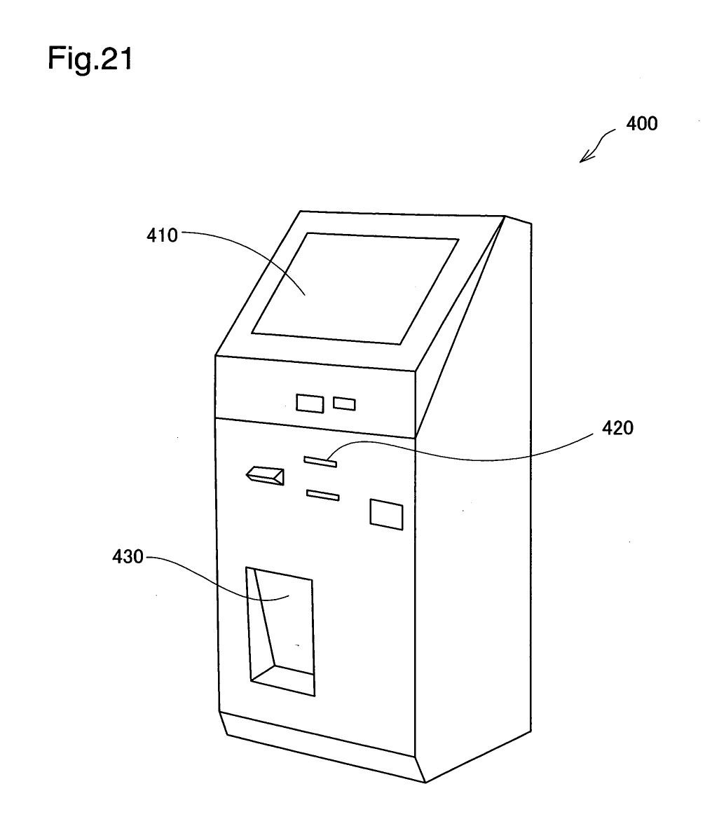

FIG. 21 illustrates the appearance of a kiosk terminal as a third embodiment of the invention. The kiosk terminal 400 is a device located on streets or in various shops, and is equipped with a ticket-issuing function, ATM function, or various guided service functions.

The kiosk terminal 400 in this embodiment is equipped with a monitor 410, memory card reader 420, and printer 430. It is also internally equipped with a CPU, RAM, and ROM. The CPU executes a control program stored in ROM by loading the program in RAM, so as to carry out the above ticket-issuing function, ATM function, or various guided service functions. The CPU also runs the control program to carry out the same processes as the various processes described in the first embodiment (printing process and blurring determination process). The kiosk terminal 400 can thus read image data from memory cards inserted into the memory card reader 420 and automatically extract focused images to display them on the monitor 410. The focused images that have thus been extracted can also be printed by the kiosk terminal 400 using the printer 430.

In this embodiment, the kiosk terminal 400 was equipped with a printer 430, but a structure without the printer 430 can also be devised. In that case, the kiosk terminal 400 ca print to a remote printer connected through certain communications lines such as a network or the Internet.

### 4. Modifications

Various embodiments of the invention have been described above, but it need hardly be pointed out that the invention is not limited to those embodiments and can assume a variety of structures within the spirit and scope of the invention.

For example, in addition to the photo viewer 300 and kiosk terminal 400, blurring can be determined by a computer, digital camera, cell phone, or the like in structures wherein the various processes noted above are carried out by such devices. After such devices determine blurring, the results may be recorded in the EXIF data of JPEG data. JPEG data in which the results of the blurring determination process have been recorded in this way can be used by printers or computers to select printing images or to carry out various image processes according to the data on blurring recorded in the EXIF data.

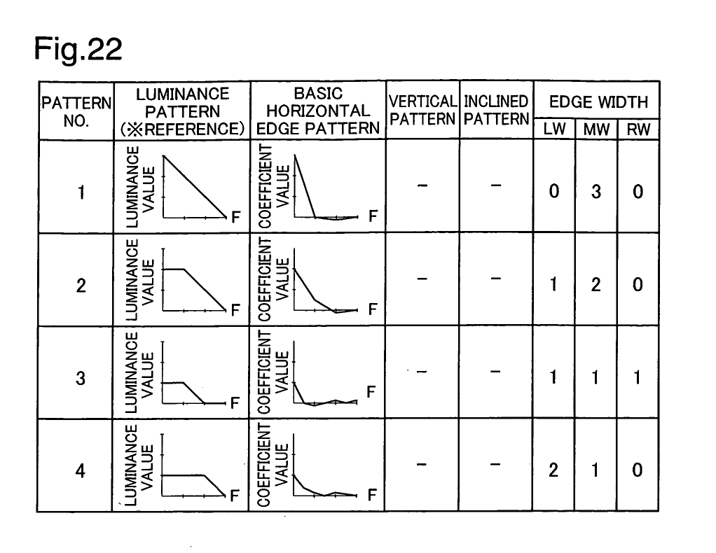

In the above embodiments, image data in the JPEG format was used as an example of image data in which were recorded two or more coefficients obtained when pixel values that are values in the spatial domain of pixels forming the image are converted to the frequency domain. However, the present invention can be applied to image data of other formats represented by coefficients in addition to image data in JPEG format. For example, DCT can be done in 4×4 pixel block units with the image format referred to as “HD Photo.” An edge pattern table can thus be prepared in advance according to the block size to allow blurring to be determined in the same manner as the above embodiments. FIG. 22 illustrates an example of an edge pattern table for a block size of 4×4. In the case of a block size of 4×4, the 16 types of basic edge patterns in FIG. 11 can be replaced by the 4 types of basic edge patterns, as shown in FIG. 22.

The coefficients recorded in the image data are not limited to coefficients obtained as a result of the DCT. For example, coefficients obtained by the DWT (discrete wavelet transform) or the Fourier transform may also be recorded in image data. Blurring can be determined in the same manner as in the above embodiments by producing an edge pattern table in advance based on coefficients obtained as a result of these transforms.

### 5. Other Aspects

In the blurring determination device of the above aspect of the invention, the blurring determination module may determine the mean width of the detected edges in each of the directions as the representative value of the width of the edges. The median of the width of the edges, or a value around it, may also be used instead of the mean.

In the blurring determination device of the above aspect, the image data for which blurring is determined can be produced based on the JPEG standard, for example. In this case, coefficients refer to so-called DCT coefficients, which are obtained by the discrete cosine transform of pixel values per block. The spatial domain can also be converted to the frequency domain using, for example, the Fourier transform or wavelet transform instead of the discrete cosine transform.

In the blurring determination device of the above aspect, the blurring determination module may determine that the image data is not blurred when the number of the detected edges is at least a certain number in each of the directions and the representative values meet the condition of being at or below a certain threshold.

According to such an aspect, when the number of edges is at or over a certain number, it is possible to determine blurring only for image data with a high likelihood of not being blurred.

In the blurring determination device of the above aspect, the image data reference module may divide the image data into band regions having a certain width and input the coefficients to memory by band region, and the edge detection module may reference the memory to detect the edges.

According to such an aspect, the amount of memory that is used can be reduced because there is no need to input all of the coefficients in the image data to memory.

In the blurring determination device of the above aspect, a plurality of the coefficients may be recorded in the image data using, as units, blocks comprising a plurality of pixels, and the edge detection module may comprise a block blurring determination module configured to divide the band regions into a plurality of window areas that are smaller than the band region, and use the basic edge patterns to determine whether each of the blocks included in the window areas is blurred, and an in-window edge detection module configured to detect the edges oriented in each of the directions in the window areas that include at least a certain number of blocks not determined to be blurred by the block blurring determination module, and the blurring determination module may determine that the image data is not blurred when the above condition is met by any window area out of the window areas including at least a certain number of blocks not determined to be blurred.

According to such an aspect, a detailed determination of blurring is made in window areas that include at least a certain number of blocks not determined to be blurred. The process can therefore be efficiently carried out. In addition, the whole image is determined to not be blurred when certain conditions are met by any window area out of such window areas. The process can therefore be rapidly carried out without the need for making a determination on blurring in the whole image.

In the blurring determination device of the above aspect, the block blurring determination module may determine whether the blocks are blurred based on the series of the coefficients in the vertical and horizontal directions, and the in-window edge detection module may detect the edges based on a series of the coefficients in the inclined direction in addition to the vertical and horizontal directions.

According to such an aspect, the edges are detected in more directions rather than determining blurring by block when determining whether or not there is blurring in windows, thus permitting more reliable determination of blurring.

In the blurring determination device of the above aspect, when the directions of the gradients of basic edge patterns corresponding to the series of the plurality of coefficients are aligned between adjacent blocks, the block blurring determination module may cumulatively add the width of the gradients and determine whether blurring straddles adjacent blocks based on the cumulatively added gradient width.

According to such an aspect, the presence or absence of blurring can be accurately determined, even when the blurred portions straddle more than one block.

In the blurring determination device of the above aspect, the basic edge patterns may be classified into and stored in a plurality of tables according to the directions of the gradient patterns represented by the basic edge patterns, and the edge detection module may select a table from among the plurality of tables according to a sign of a certain coefficient in the series of the plurality of coefficients.

According to such an aspect, blurring can be determined more rapidly because the number of comparisons between the basic edge patterns and the series of coefficients in the image data can be reduced.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A blurring determination device comprising:
an image data reference module configured to reference image data in which has been recorded coefficients that are obtained when pixel values forming the image in the spatial domain are converted to the frequency domain;
an edge detection module configured to detect edges oriented in two or more directions, from among the image data, by comparing a series of the coefficients in each of the directions with various types of basic edge patterns whereby typical gradient patterns of the changes in pixel values are represented by values corresponding to the coefficients; and
a blurring determination module configured to determine the representative values of the width of the detected edges in each of the directions and determine that the image data is not blurred when the representative values meet the condition of being at or below a certain threshold.

2. A blurring determination device according to claim 1, wherein
the blurring determination module determines the mean width of the detected edges in each of the directions as the representative value of the width of the edges.

3. A blurring determination device according to claim 1, wherein
the blurring determination module determines that the image data is not blurred when the number of the detected edges is at least a certain number in each of the directions and the representative values meet the condition of being at or below a certain threshold.

4. A blurring determination device according to claim 1, wherein
the image data reference module divides the image data into band regions having a certain width and inputs the coefficients to memory by band region, and
the edge detection module references the memory to detect the edges.

5. A blurring determination device according to claim 4, wherein
a plurality of the coefficients are recorded in the image data using, as units, blocks comprising a plurality of pixels, and
the edge detection module comprises
a block blurring determination module configured to divide the band regions into window areas that are smaller than the band region, and use the basic edge patterns to determine whether each of the blocks included in the window areas is blurred and
an in-window edge detection module configured to detect the edges oriented in each of the directions in the window areas that include at least a certain number of blocks not determined to be blurred by the block blurring determination module, and
the blurring determination module determines that the image data is not blurred when the condition is met by any window area out of the window areas including at least a certain number of blocks not determined to be blurred.

6. A blurring determination device according to claim 5, wherein
the block blurring determination module determines whether the blocks are blurred based on the series of the coefficients in the vertical and horizontal directions, and
the in-window edge detection module detects the edges based on a series of the coefficients in the inclined direction in addition to the vertical and horizontal directions.

7. A blurring determination device according to claim 6, wherein
when directions of the gradients of basic edge patterns corresponding to the series of the plurality of coefficients are aligned between adjacent blocks, the block blurring determination module cumulatively adds the width of the gradients and determines whether blurring straddles adjacent blocks based on the cumulatively added gradient width.

8. A blurring determination device according to claim 1, wherein
the basic edge patterns are classified into and stored in a plurality of tables according to directions of the gradient patterns represented by the basic edge patterns, and
the edge detection module selects a table from among the plurality of tables according to a sign of a certain coefficient in the series of the plurality of coefficients.

9. A blurring determination device according to claim 1, wherein
the image data is produced based on the JPEG standard, and the coefficients are obtained by the discrete cosine transform of pixel values per block.

10. A blurring determination method comprising:
referencing image data in which has been recorded coefficients that are obtained when pixel values forming the image in the spatial domain are converted to the frequency domain;
detecting edges oriented in two or more directions, from among the image data, by comparing a series of the coefficients in each of the directions with various types of basic edge patterns whereby typical gradient patterns of the changes in pixel values are represented by values corresponding to the coefficients; and
determining the representative values of the width of the detected edges in each of the directions and determining that the image data is not blurred when the representative values meet the condition of being at or below a certain threshold.

11. A computer program product for determining whether or not images are blurred, the computer program product comprising:
a computer readable medium; and
a computer program stored on the computer readable medium, the computer program causing a computer to implement the functions of:
referencing image data in which has been recorded coefficients that are obtained when pixel values forming the image in the spatial domain are converted to the frequency domain;
detecting edges oriented in two or more directions, from among the image data, by comparing a series of the coefficients in each of the directions with various types of basic edge patterns whereby typical gradient patterns of the changes in pixel values are represented by values corresponding to the coefficients; and
determining the representative values of the width of the detected edges in each of the directions and determining that the image data is not blurred when the representative values meet the condition of being at or below a certain threshold.
